(19) United States
(12) Patent Application Publication
(10) Pub. No.: US 2026/0088503 A1
(43) Pub. Date: Mar. 26, 2026

(54) ANTENNA DEVICE AND COMMUNICATION APPARATUS

(71) Applicant: Wistron NeWeb Corp., Hsinchu (TW)

(72) Inventors: HAO-JU HSIEH, HSINCHU (TW); CHIEN-TING HUANG, HSINCHU (TW); CHI-KANG SU, HSINCHU (TW)

(21) Appl. No.: 19/188,133

(22) Filed: Apr. 24, 2025

Related U.S. Application Data
(60) Provisional application No. 63/697,614, filed on Sep. 23, 2024.

(30) Foreign Application Priority Data
Mar. 18, 2025 (TW) 114109977

(51) Int. Cl. H01Q 5/307; H01Q 1/22; H01Q 5/50

(52) U.S. Cl. CPC H01Q 5/307; H01Q 1/22; H01Q 5/50

(57) ABSTRACT

An antenna device and a communication apparatus. The antenna device includes a base, a standing member, an arm, and a first radiation portion. The standing member is connected to and stands on the base. The arm includes a first arm and a second arm, and the arm is connected to the standing member. The first radiation portion includes a first part and a second part that are symmetrical to each other, the first part of the first radiation portion is connected to the first arm, and the second part of the first radiation portion is connected to the second arm. The arm and the base are connected to different positions of the standing member, such that there is a distance between the arm and the base in a direction perpendicular to the base.

### CROSS-REFERENCE TO RELATED PATENT APPLICATION

This application claims the benefit of priority to the U.S. Provisional Patent Application Ser. No. 63/697,614 filed on Sep. 23, 2024, and Taiwan Patent Application No. 114109977 filed on Mar. 18, 2025. The entire content of the above identified applications are incorporated herein by reference.

Some references, which may include patents, patent applications and various publications, may be cited and discussed in the description of the present disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to antenna devices and communication apparatuses, particularly antenna devices and communication apparatuses capable of supporting multiple frequency bands.

### BACKGROUND OF THE DISCLOSURE

In recent years, wireless communication products not only require miniaturization but also require antennas to cover multiple frequency bands to support communications at different frequencies. Under the limited space of wireless communication products, it has become a challenge to enable antennas to cover multiple frequency bands. Additionally, manufacturers also have requirements on the gain, beamwidth, directivity, and other radiation pattern specifications for antennas, which further increases the difficulty on antenna design. Conventional high-gain directive antennas have mostly focused on a single frequency band; with the development of wireless communication technologies, there is a need for an antenna that is small-sized, provides radiation patterns with directivity and a certain beamwidth, and supports multiple frequency bands.

### SUMMARY OF THE DISCLOSURE

An antenna device includes: a base; a standing member connected to and standing on the base; an arm that includes a first arm and a second arm, the arm is connected to the standing member; and a first radiation portion that includes a first part and a second part that are symmetrical to each other. The first part of the first radiation portion is connected to the first arm, and the second part of the first radiation portion is connected to the second arm. The arm and the base are connected to different positions of the standing member, such that there is a distance between the arm and the base in a direction perpendicular to the base.

A communication apparatus includes: a bottom plate and an antenna device. The antenna device includes: a base mounted on the bottom plate; a standing member connected to and standing on the base; an arm that includes a first arm and a second arm, the arm is connected to the standing member; and a first radiation portion that includes a first part and a second part that are symmetrical to each other. The first part of the first radiation portion is connected to the first arm, and the second part of the first radiation portion is connected to the second arm. The arm and the base are connected to different positions of the standing member, such that there is a distance between the arm and the base in a direction perpendicular to the base.

These and other aspects of the present disclosure will become apparent from the following description of the embodiment taken in conjunction with the attached drawings and their captions, although variations and modifications therein may be affected without departing from the spirit and scope of the present disclosure.

### BRIEF DESCRIPTION OF THE DRAWINGS

The described embodiments may be better understood by reference to the following description and the accompanying drawings.

FIG. 1A, FIG. 1B, and FIG. 1C show schematic views of an antenna device according to a first embodiment of the present disclosure, wherein FIG. 1A and FIG. 1B show different perspectives of the antenna device, and FIG. 1C shows the relative position between the antenna device and a top plate.

FIG. 2A, FIG. 2B, and FIG. 2C show schematic views of an antenna device according to a second embodiment of the present disclosure, wherein FIG. 2A and FIG. 2B show different perspectives of the antenna device, and FIG. 2C shows the relative position between the antenna device and a top plate.

FIG. 3 shows how the distance between the first radiation portion and the second radiation portion of the antenna device affects the antenna radiation pattern according to some embodiments of the present disclosure.

FIG. 4 shows how the length of the standing member of the antenna device affects the voltage standing wave ratio (VSWR) of the antenna signal according to some embodiments of the present disclosure.

FIG. 5 shows how the length of the slot of the antenna device affects the voltage standing wave ratio (VSWR) of the antenna signal according to some embodiments of the present disclosure.

FIG. 6 shows how of the bending angle of the first radiation portion of the antenna device affects the beamwidth of the antenna signal according to some embodiments of the present disclosure.

FIG. 7 shows how the distance between the antenna device and the top plate affects the peak gain according to some embodiments of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

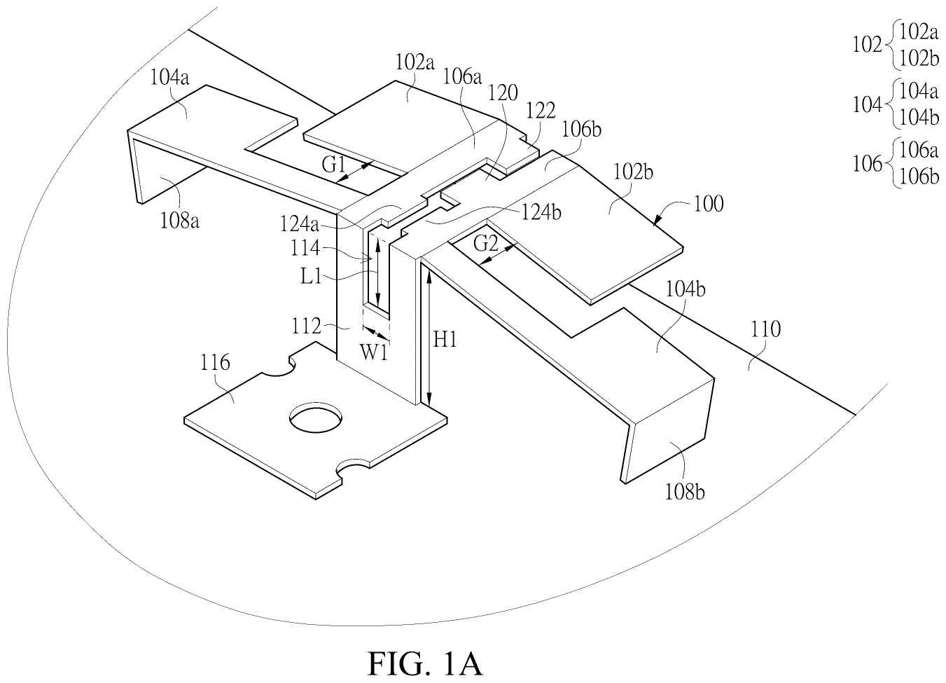

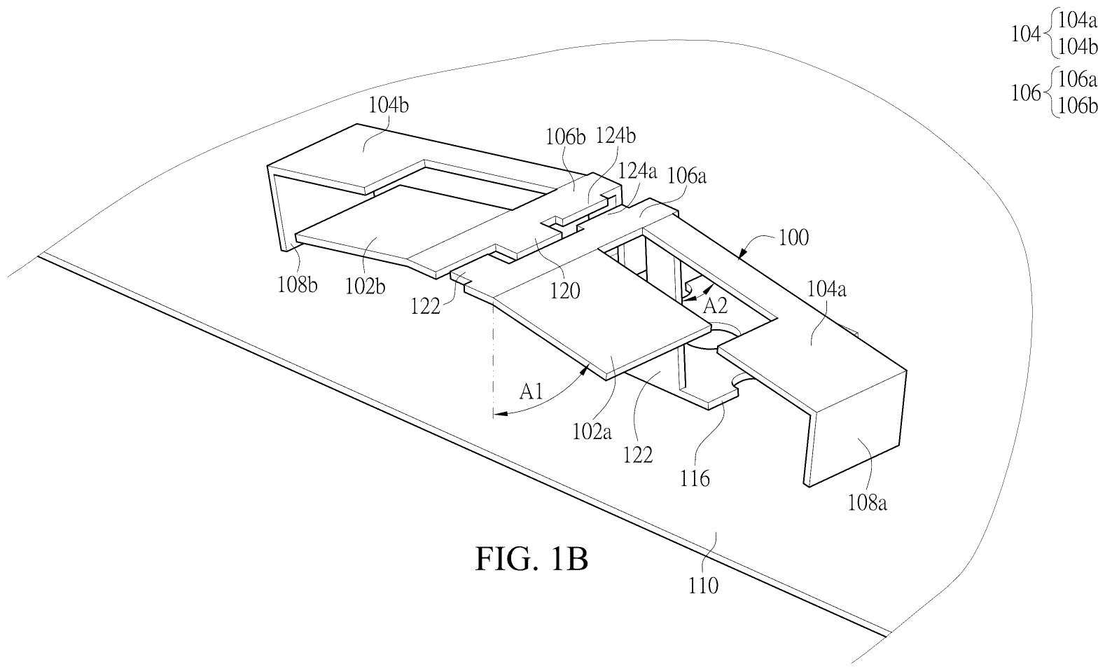

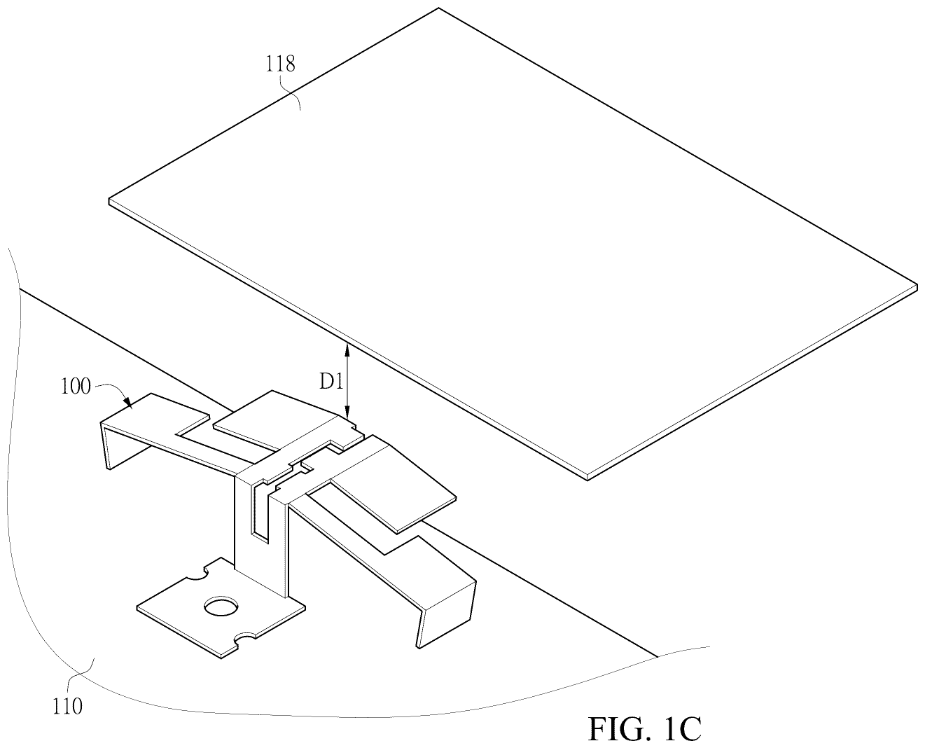

FIG. 1A, FIG. 1B, and FIG. 1C show schematic views of an antenna device 100 according to a first embodiment of the present disclosure. FIG. 1A and FIG. 1B show different perspectives of the antenna device 100, while FIG. 1C shows the relative position between the antenna device 100 and a top plate 118. FIG. 1A, FIG. 1B, and FIG. 1C can be referenced together.

The antenna device 100 can be regarded as a result derived from the concept of a dipole antenna. The antenna device 100 is capable of simultaneously supporting multi-band signal transmission, providing a high-gain directional radiation pattern, and covering a wide frequency band. For example, in some embodiments, the antenna device 100 can support Wi-Fi operations at 2.4 GHz, 5 GHZ, and 6 GHz simultaneously. The antenna device 100 can also adjust the beamwidth of the antenna radiation signal according to product specification requirements.

The antenna device 100 includes a first radiation portion 102, a second radiation portion 104, an arm 106, a standing member 112, and a base 116.

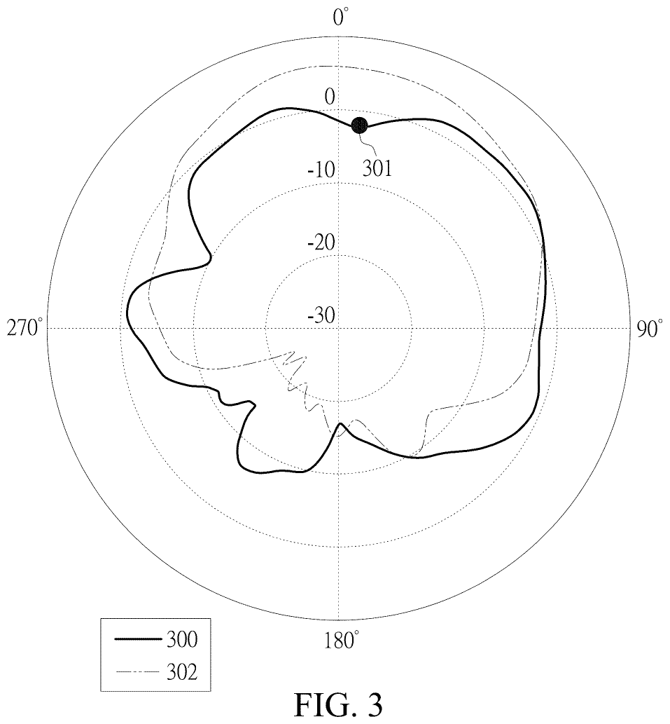

The first radiation portion 102 includes a first part 102a and a second part 102b, and the second radiation portion 104 includes a first part 104a and a second part 104b. The first part 102a and the second part 102b of the first radiation portion 102 can be symmetrical to each other, and the first part 104a and the second part 104b of the second radiation portion 104 can be symmetrical to each other. The arm 106 includes a first arm 106a and a second arm 106b. The first part 102a of the first radiation portion 102 and the first part 104a of the second radiation portion 104 are connected to the first arm 106a. The second part 102b of the first radiation portion 102 and the second part 104b of the second radiation portion 104 are connected to the second arm 106b. The first part 102a of the first radiation portion 102 and the first part 104a of the second radiation portion 104 are spaced apart by a first spacing G1 in a direction connecting each other via the first arm 106a. The second part 102b of the first radiation portion 102 and the second part 104b of the second radiation portion 104 are spaced apart by a second spacing G2 in a direction connecting each other via the second arm 106b. In this embodiment, the first spacing G1 and the second spacing G2 have the same size. The first spacing G1 and the second spacing G2 can reduce the mutual interference between the first radiation portion 102 and the second radiation portion 104, and allow the antenna device 100 to achieve a good directional radiation pattern. The effect of different sizes of the first spacing G1 and the second spacing G2 on the radiation pattern of the antenna device 100 will be described subsequently in FIG. 3.

The first part 104a and the second part 104b of the second radiation portion 104 can be partially cut out to allow bringing the second radiation portion 104 closer to the first radiation portion 102, thereby reducing the space occupied by the antenna device 100. The cutout shape of the second radiation portion 104 can correspond to the first radiation portion 102. For example, as shown in FIG. 1A, if the first radiation portion 102 is rectangular, then the cutout part of the second radiation portion 104 can be a corresponding rectangle.

The base 116 of the antenna device 100 can be fixed to the bottom plate 110; for example, the base 116 can have holes for allowing screws or other fasteners to mount the antenna device 100 onto the bottom plate 110. The standing member 112 is connected to and stands on the base 116. In this embodiment, the standing member 112 is perpendicular to the base 116; that is, a 90-degree angle is formed between the standing member 112 and the base 116. In some variant embodiments, the standing member 112 and the base 116 may also form angles other than 90 degrees. In other variant embodiments, the standing member 112 can be directly fixed to the bottom plate 110 without the base 116, in which case the bottom plate 110 can be considered as the base of the antenna device 100.

The arm 106 is connected to the standing member 112, and more specifically, the first arm 106a and the second arm 106b are each connected to the standing member 112. The standing member 112 has a length H1. The arm 106 and the base 116 are connected at different positions of the standing member 112, such that there is a distance between the arm 106 and the base 116 in a direction perpendicular to the base 116, wherein such distance can be the same as or different from the length H1 of the standing member 112. In this embodiment, the base 116 is perpendicular to the standing member 112, the base 116 is parallel to the arm 106, and the arm 106 and the base 116 are connected at opposite ends of the standing member 112, so the distance between the arm 106 and the base 116 is equal to the length H1 of the standing member 112. Additionally, since the base 116 can be designed to be flat, the distance between the arm 106 and the bottom plate 110 can also approximate the length H1. In some variant embodiments, the arm 106 may not necessarily be connected at the end of the standing member 112; in this case, the distance between the arm 106 and the base 116 would not be equal to the length H1 of the standing member 112.

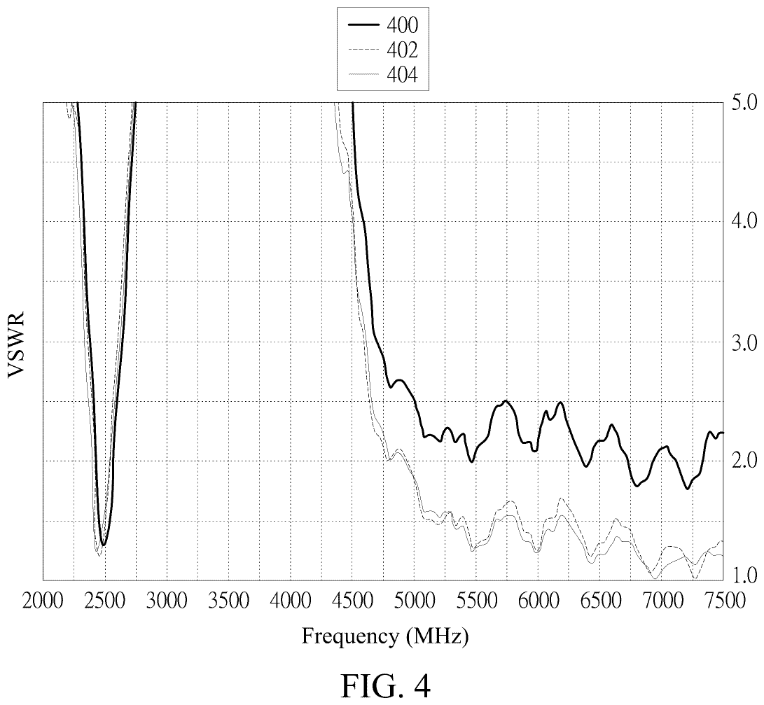

The arm 106 can be cantilevered from the standing member 112. The term “cantilevered” refers to a component connected at one end (the fixed end) to another component, while the other end (the free end) is suspended. For example, as shown in FIG. 1A, the arm 106 is elevated by the standing member 112 such that its vertical position higher than the base 116, the fixed end of the arm 106 is connected to the standing member 112, and the arm 106 extends from the fixed end away from the standing member 112, causing the free end that is opposite to fixed end to become suspended. Similarly, the first part 102a of the first radiation portion 102 and the first part 104a of the second radiation portion 104 are cantilevered from the first arm 106a, and the second part 102b of the first radiation portion 102 and the second part 104b of the second radiation portion 104 are cantilevered from the second arm 106b. Since the standing member 112 elevates the arm 106, the first radiation portion 102, and the second radiation portion 104, the first radiation portion 102 and the second radiation portion 104 respectively form a distance from the bottom plate 110, which reduces the impact of the bottom plate 110 on the first radiation portion 102 and the second radiation portion 104, allowing the first radiation portion 102 and the second radiation portion 104 to produce a broadband effect. The impact on the radiation signal caused by the distance formed between the first radiation portion 102 and the second radiation portion 104 with the bottom plate 110 will be described subsequently in FIG. 4.

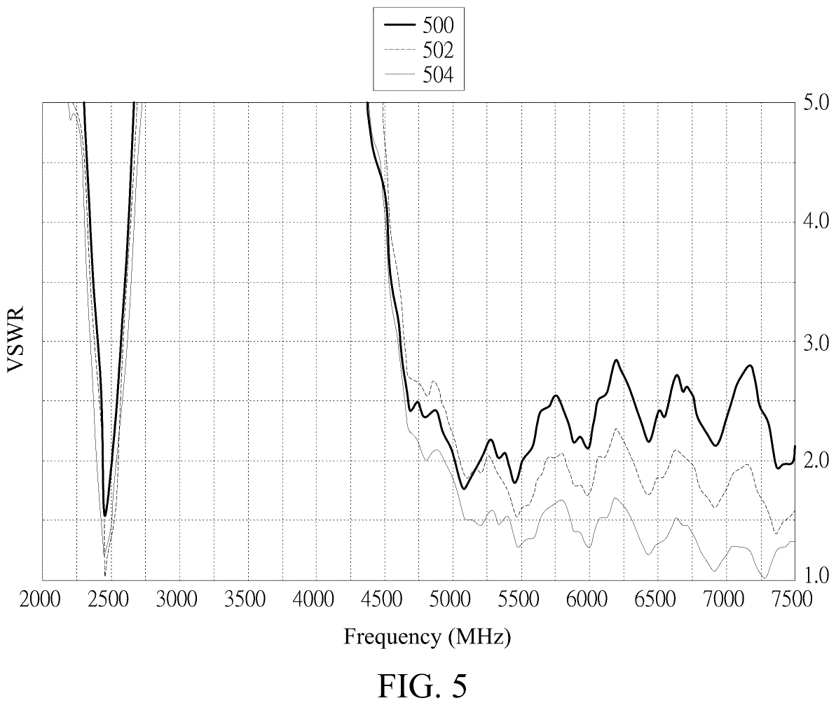

The standing member 112 is provided with a slot 114 therein, and the slot 114 has a length L1. In this embodiment, the first arm 106a and the second arm 106b are parallel to each other, and the gap between the first arm 106a and the second arm 106b is equal to the width W1 of the slot 114. The slot 114 affects the impedance matching of the antenna device 100, thereby affecting the antenna signal; this will be described subsequently in FIG. 5.

The first radiation portion 102 and the second radiation portion 104 of the antenna device 100 can support signals at different frequency bands. Specifically, the first radiation portion 102 can operate in a first frequency band, and the second radiation portion 104 can operate in a second frequency band that is different from the first frequency band. The total length of the first radiation portion 102 is approximately equal to 0.5 times the wavelength corresponding to the first frequency band (hereinafter simply referred to as 0.5 times the wavelength of the first frequency band). For example, the lengths of the first part 102a and the second part 102b of the first radiation portion 102 can each be approximately 0.25 times the wavelength of the first frequency band, such that the total length of the first part 102a and the second part 102b of the first radiation portion 102 is approximately 0.5 times the wavelength of the first frequency band. Similarly, the total length of the second radiation portion 104 is approximately equal to 0.5 times the wavelength of the second frequency band. For example, the lengths of the first part 104a and the second part 104b of the second radiation portion 104 can each be approximately 0.25 times the wavelength of the second frequency band, such that the total length of the first part 104a and the second part 104b of the second radiation portion 104 is approximately 0.5 times the wavelength of the second frequency band. In some embodiments, the first radiation portion 102 can support signals in the 5 GHz and 6 GHz frequency bands, while the second radiation portion 104 can support signals in the 2.4 GHz frequency band. In some variant embodiments, the lengths of the first radiation portion 102 and the second radiation portion 104 can be adjusted to support signals in other frequency bands.

The first part 104a and the second part 104b of the second radiation portion 104 can respectively have bending parts 108a and 108b. The bending parts 108a, 108b are respectively bent into an L-shape at an end of the first part 104a and the second part 104b of the second radiation portion 104, which can reduce the lateral space occupied by the antenna device 100. For example, the antenna device 100 can be placed inside a communication apparatus; when the size of the communication apparatus is required to be smaller, the ends of the first part 104a and the second part 104b of the second radiation portion 104 can be bent to form bending parts 108a and 108b, allowing the antenna device 100 to be accommodated in a limited space. In some variant embodiments, the ends of the first part 102a and the second part 102b of the first radiation portion 102 may also undergo a similar bending. If the space accommodating the antenna device 100 is large enough, the ends of the first part 104a and the second part 104b of the second radiation portion 104 may be unbent.

The antenna device 100 may further include a feeding terminal 120 and a grounding terminal 122 for signals, wherein the grounding terminal 122 is connected to the first arm 106a, and the feeding terminal 120 is connected to the second arm 106b. In some variant embodiments, the grounding terminal 122 may be connected to the second arm 106b, and the feeding terminal 120 may be connected to the first arm 106a. Additionally, although FIG. 1A to FIG. 1C shows the feeding terminal 120 and the grounding terminal 122 positioned in a staggered arrangement, the feeding terminal 120 and the grounding terminal 122 can also be arranged to face each other. The antenna device 100 may also further include a first matching protrusion 124a and a second matching protrusion 124b for adjusting impedance matching, wherein the first matching protrusion 124a is connected to the first arm 106a, and the second matching protrusion 124b is connected to the second arm 106b. FIG. 1A to FIG. 1C shows the feeding terminal 120, grounding terminal 122, first matching protrusion 124a, and second matching protrusion 124b as rectangles, but the feeding terminal 120, grounding terminal 122, first matching protrusion 124a, and second matching protrusion 124b can also be configured as other shapes.

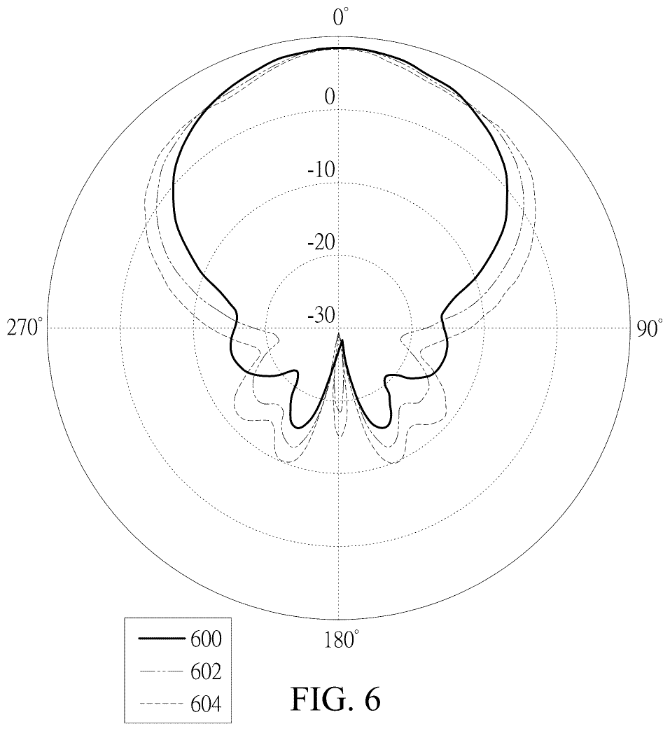

As shown in FIG. 1B, the first radiation portion 102 and the second radiation portion 104 can bend towards the bottom plate 110. Specifically, the first part 102a and the second part 102b of the first radiation portion 102 each form a first angle A1 with a Z-axis perpendicular to the base 116 (or the bottom plate 110), and the first part 104a and the second part 104b of the second radiation portion 104 each form a second angle A2 with the Z-axis, wherein the first angle A1 can be between 30 degrees and 90 degrees, and the second angle A2 can also be between 30 degrees and 90 degrees. The first angle A1 and the second angle A2 can be the same or different. Adjusting the first angle A1 and the second angle A2 can affect the beamwidth of the antenna signal, which will be described subsequently in FIG. 6.

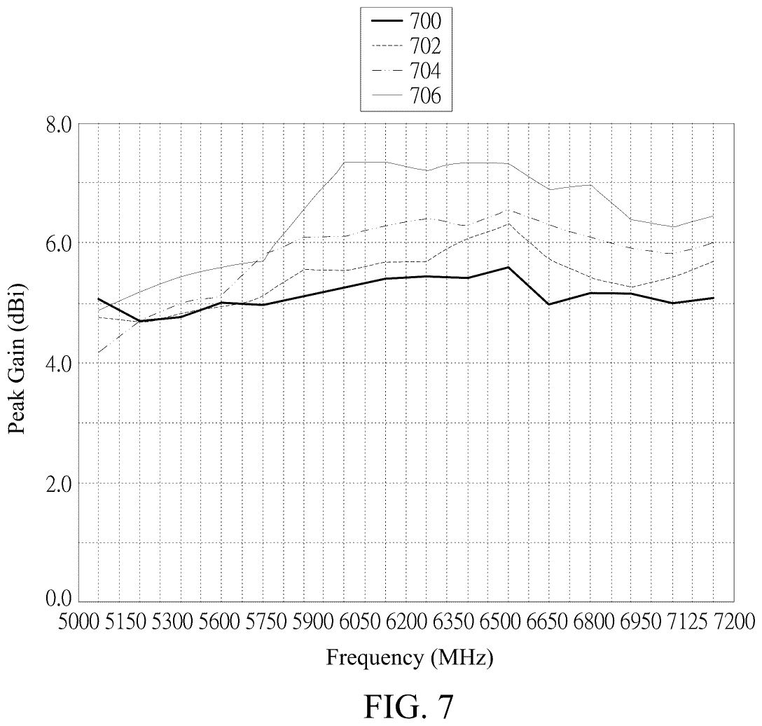

The antenna device 100 can be placed in a communication apparatus such as an access point device, a router, etc., wherein the communication apparatus can include a bottom plate 110 and a top plate 118 (refer to FIG. 1C), and there can be a distance D1 between the antenna device 100 and the top plate 118. In this embodiment, the arm 106 of the antenna device 100 is parallel to the top plate 118 and is closest to the top plate 118, so the distance D1 is also equal to the distance between the arm 106 and the top plate 118. In some variant embodiments, if the arm 106 is not parallel to the top plate 118, or if components other than the arm 106 are closer to the top plate 118, then the distance D1 will be taken as the minimum distance between the antenna device 100 and the top plate 118. The distance D1 between the antenna device 100 and the top plate 118 affects the peak gain of the antenna signal, which will be described subsequently in FIG. 7.

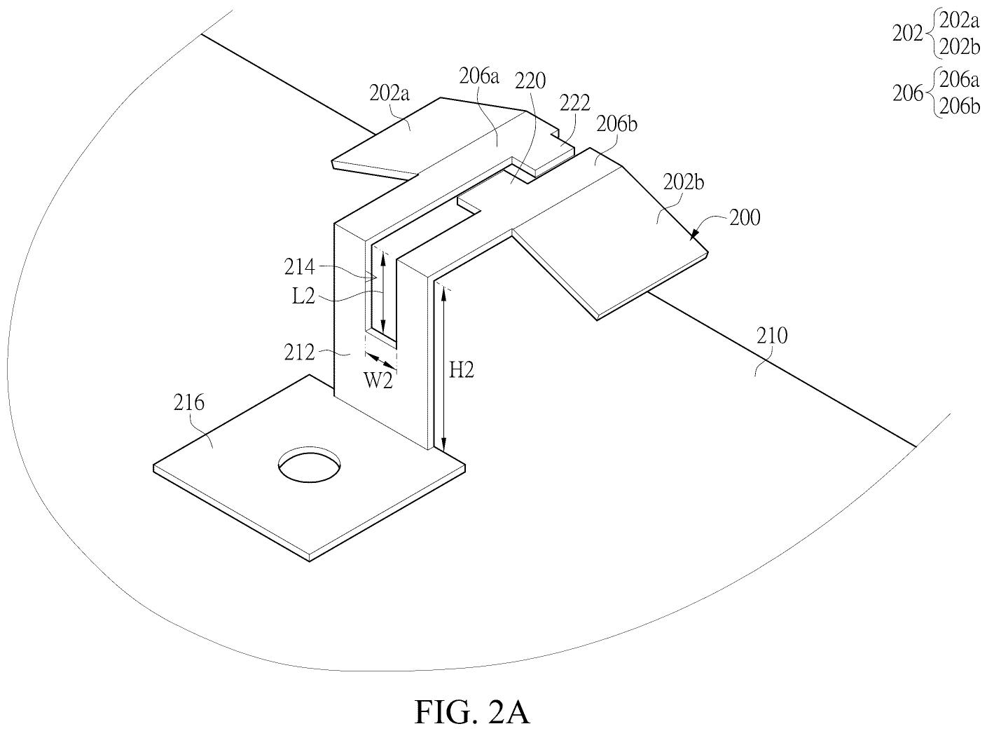

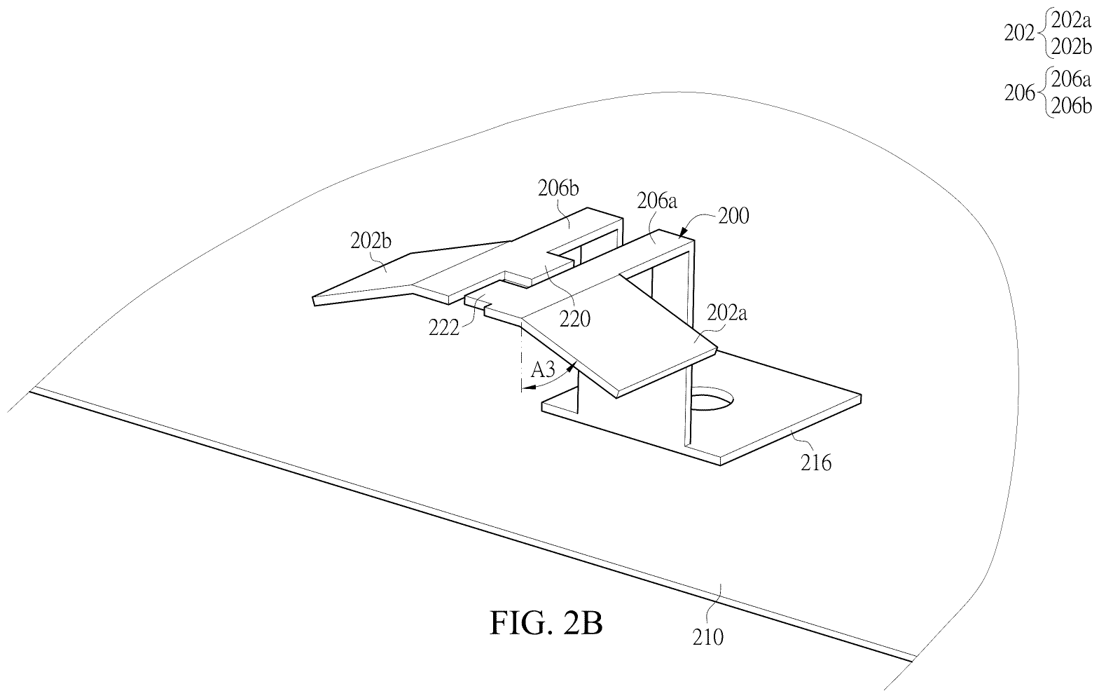

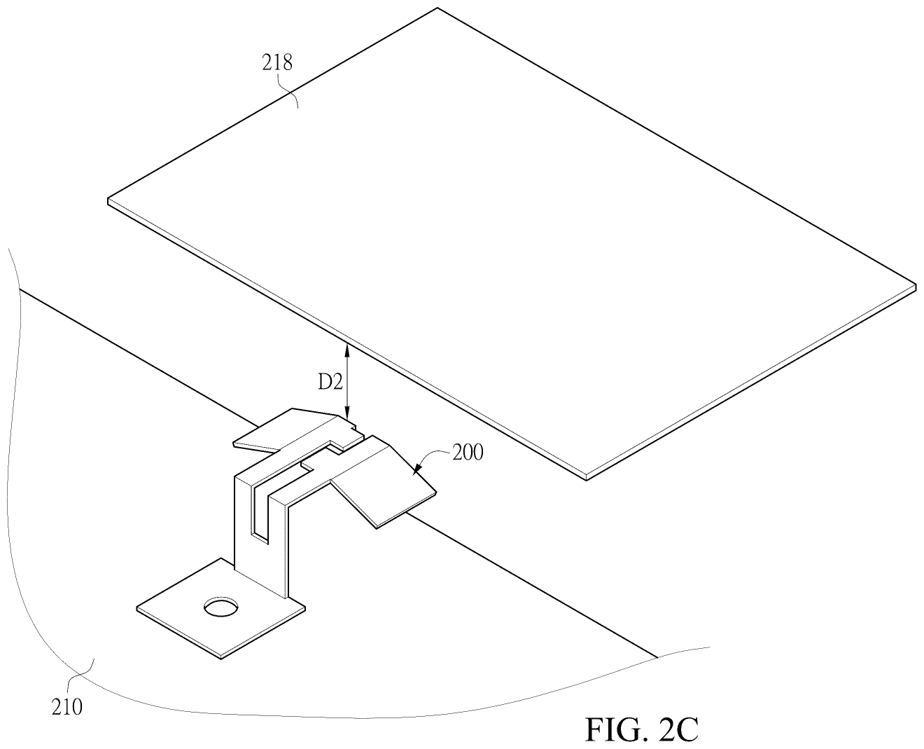

FIG. 2A, FIG. 2B, and FIG. 2C show schematic views of the antenna device 200 according to a second embodiment of the present disclosure. FIG. 2A and FIG. 2B show different perspectives of the antenna device 200, while FIG. 2C shows the relative position between the antenna device 200 and the top plate 218. FIG. 2A, FIG. 2B, and FIG. 2C can be referenced together.

The antenna device 200 can be regarded as a result derived from the concept of a dipole antenna. The antenna device 200 is capable of providing a high-gain directional radiation pattern and can cover a wide frequency band. For example, in some embodiments, the antenna device 200 can support Wi-Fi operations at 5 GHz and 6 GHz simultaneously. The antenna device 200 can also adjust the beamwidth of the antenna radiation signal according to product specification requirements.

The antenna device 200 includes a first radiation portion 202, an arm 206, a standing member 212, and a base 216. The first radiation portion 202 of the antenna device 200 is similar to the first radiation portion 102 of the antenna device 100. The first radiation portion 202 includes a first part 202a and a second part 202b, wherein the first part 202a and the second part 202b of the first radiation portion 202 can be symmetrical to each other. The arm 206 includes a first arm 206a and a second arm 206b. The first part 202a of the first radiation portion 202 is connected to the first arm 206a, while the second part 202b of the first radiation portion 202 is connected to the second arm 206b.

The base 216 of the antenna device 200 can be fixed to the bottom plate 210; for example, the base 216 can have holes for allowing screws or other fasteners to mount the antenna device 200 onto the bottom plate 210. The standing member 212 is connected to and stands on the base 216. In this embodiment, the standing member 212 is perpendicular to the base 216; that is, a 90-degree angle is formed between the standing member 212 and the base 216. In some variant embodiments, the standing member 212 and the base 216 may also form angles other than 90 degrees. In other variant embodiments, the standing member 212 can be directly fixed to the bottom plate 210 without the base 216, in which case the bottom plate 210 can be considered as the base of the antenna device 200.

The arm 206 is connected to the standing member 212, and more specifically, the first arm 206a and the second arm 206b are each connected to the standing member 212. The standing member 212 has a length H2. The arm 206 and the base 216 are connected at different positions of the standing member 212, such that there is a distance between the arm 206 and the base 216 in a direction perpendicular to the base 216, wherein such distance can be the same as or different from the length H2 of the standing member 212. In this embodiment, the base 216 is perpendicular to the standing member 212, the base 216 is parallel to the arm 206, and the arm 206 and the base 216 are connected at opposite ends of the standing member 212, so the distance between the arm 206 and the base 216 is equal to the length H2 of the standing member 212. Additionally, since the base 216 can be designed to be flat, the distance between the arm 206 and the bottom plate 210 can also approximate the length H2. In some variant embodiments, the arm 206 may not necessarily be connected at the end of the standing member 212; in this case, the distance between the arm 206 and the base 216 would not be equal the length H2 of the standing member 212.

The arm 206 can be cantilevered from the standing member 212. As shown in FIG. 2A, the arm 206 is elevated by the standing member 212 such that its vertical position higher than the base 216, the fixed end of the arm 206 is connected to the standing member 212, and the arm 206 extends from the fixed end away from the standing member 212, causing the free end that is opposite to the fixed end to become suspended. Similarly, the first part 202a of the first radiation portion 202 is cantilevered from the first arm 206a, and the second part 202b of the first radiation portion 202 is cantilevered from the second arm 206b. Since the standing member 212 elevates the arm 206 and the first radiation portion 202, there is a distance between the first radiation portion 202 and the bottom plate 210, which reduces the impact of the bottom plate 210 on the first radiation portion 202, allowing the first radiation portion 202 to produce a broadband effect.

The standing member 212 is provided with a slot 214 therein, and the slot 214 has a length L2. In this embodiment, the first arm 206a and the second arm 206b are parallel to each other, and the gap between the first arm 206a and the second arm 206b is equal to the width W2 of the slot 214. The slot 214 affects the impedance matching of the antenna device 200, thereby affecting the antenna signal.

The first radiation portion 202 of the antenna device 200 can operate in a first frequency band, and the total length of the first radiation portion 202 is approximately equal to 0.5 times the wavelength corresponding to the first frequency band (hereinafter simply referred to as 0.5 times the wavelength of the first frequency band). For example, the lengths of the first part 202a and the second part 202b of the first radiation portion 202 can each be approximately 0.25 times the wavelength of the first frequency band, such that the total length of the first part 202a and the second part 202b of the first radiation portion 202 is approximately 0.5 times the wavelength of the first frequency band. In some embodiments, the first radiation portion 202 can support signals in the 5 GHz and 6 GHz frequency bands. In some variant embodiments, the length of the first radiation portion 202 can be adjusted to support signals in other frequency bands.

The antenna device 200 may further include a feeding terminal 220 and a grounding terminal 222 for signals, wherein the grounding terminal 222 is connected to the first arm 206a, and the feeding terminal 220 is connected to the second arm 206b. In some variant embodiments, the grounding terminal 222 may be connected to the second arm 206b, and the feeding terminal 220 may be connected to the first arm 206a. Additionally, although FIG. 2A to FIG. 2C shows the feeding terminal 220 and the grounding terminal 222 positioned in a staggered arrangement, the feeding terminal 220 and the grounding terminal 222 can also be arranged to face each other. The feeding terminal 220 and the grounding terminal 222 are shown as rectangles in FIG. 2A to FIG. 2C, but the feeding terminal 220 and the grounding terminal 222 can also be configured as other shapes.

Compared to the antenna device 100 of the first embodiment, the antenna device 200 of the second embodiment does not have impedance matching protrusions; however, impedance matching protrusions can be added to the antenna device 200 similar to the setup of antenna device 100 for impedance matching if desired.

As shown in FIG. 2B, the first part 202a and the second part 202b of the first radiation portion 202 each form a third angle A3 with the Z-axis perpendicular to the base 216, wherein the third angle A3 can be between 30 degrees and 90 degrees. Adjusting the third angle A3 can affect the beamwidth of the antenna signal. In some embodiments, the third angle A3 in FIG. 2B corresponds to the first angle A1 in FIG. 1B.

The antenna device 200 can be placed in a communication apparatus such as an access point devices, a router, etc., wherein the communication apparatus can include a bottom plate 210 and a top plate 218 (refer to FIG. 2C), and there can be a distance D2 between the antenna device 200 and the top plate 218. In this embodiment, the arm 206 of the antenna device 200 is parallel to the top plate 218 and is closest to the top plate 218, so the distance D2 is also equal to the distance between the arm 206 and the top plate 218. In some variant embodiments, if the arm 206 is not parallel to the top plate 218, or if components other than the arm 206 are closer to the top plate 218, then the distance D2 will be taken as the minimum distance between the antenna device 200 and the top plate 218. The distance D2 between the antenna device 200 and the top plate 218 affects the peak gain of the antenna signal.

FIG. 3 shows how the distance between the first radiation portion 102 and the second radiation portion 104 of the antenna device 100 affects the antenna radiation pattern. As previously shown in FIG. 1A, there is a first spacing G1 between the first part 102a of the first radiation portion 102 and the first part 104a of the second radiation portion 104 in the direction connecting each other via the first arm 106a. There is also a second spacing G2 between the second part 102b of the first radiation portion 102 and the second part 104b of the second radiation portion 104 in the direction connecting each other via the second arm 106b. Since the first spacing G1 and the second spacing G2 have the same size in the first embodiment, the following content will only describe the first spacing G1.

The radiation pattern graph in FIG. 3 shows the antenna radiation intensity (measured in dB) in the elevation plane. The radiation pattern 300 is the result measured when the first spacing G1 is 3 mm, while the radiation pattern 302 is the result measured when the first spacing G1 is 6 mm. It can be seen from FIG. 3 that the radiation pattern 302 has directionality around 0 degrees, while the radiation pattern 300 not only lacks obvious directionality, but also produces a null point 301 resulting in a poor signal gain near the 0-degree direction. Therefore, if the design requires the antenna device 100 to achieve directional radiation patterns, the radiation pattern 302 is preferable. When the first spacing G1 is too small, it may likely lead to interference between the first radiation portion 102 and the second radiation portion 104. According to test results, the first spacing G1 being 5 mm or more will achieve better radiation directionality.

FIG. 4 shows how the length H1 of the standing member 112 of the antenna device 100 affects the voltage standing wave ratio (VSWR) of the antenna signal. VSWR can be used to evaluate the reflection situation during antenna signal transmission; when VSWR is 1, it indicates that there is no reflection of the antenna signal, so a VSWR being close to 1 is desirable. Curve 400 represents the VSWR measured when the length H1 is 8 mm, curve 402 represents the VSWR measured when the length H1 is 10 mm, and curve 404 represents the VSWR measured when the length H1 is 12 mm. The antenna device 100 is configured to operate in the frequency bands of 2.4 GHZ, 5 GHZ, and 6 GHZ, wherein it can be seen from FIG. 4 that the VSWR of curve 400 is larger than that of curves 402 and 404, and the VSWR of curves 402 and 404 is closer to 1 in the aforementioned frequency bands. Therefore, selecting a length H1 10 mm or more is preferable. As previously mentioned, a larger length H1 can reduce the impact of the bottom plate 110 on the first radiation portion 102 and the second radiation portion 104; however, in actual situations, the antenna device 100 installed in communication apparatus may be subject to spatial limitations, so there may be an upper limit to the length H1. Choosing the length H1 to be between 10 mm and 12 mm can maintain a low VSWR while not occupying too much space, thus achieving a good balance between VSWR and spatial limitations. Although the curves in FIG. 4 are measured using the antenna device 100, the antenna device 200 also has similar characteristics, meaning that different sizes for the length H2 of the standing member 212 of the antenna device 200 will affect the signal in a similar manner, and the length H2 can be selected to be 10 mm or more to achieve better VSWR in the 5 GHz and 6 GHz frequency bands.

FIG. 5 shows how the length L1 of the slot 114 of the antenna device 100 affects the voltage standing wave ratio (VSWR) of the antenna signal. Curve 500 represents the VSWR measured when the length L1 is 1 mm, curve 502 represents the VSWR measured when the length L1 is 3 mm, and curve 504 represents the VSWR measured when the length L1 is 5 mm. It can be seen from FIG. 5 that in the 5 GHz and 6 GHz frequency bands, curve 500 has a larger VSWR, while curve 504 has a smaller VSWR and is closest to 1. According to the measurement results in FIG. 5, the length L1 of the slot 114 can be selected to be at least 5 mm to allow the antenna device 100 to achieve good impedance matching, thereby reducing the VSWR. Although the curves in FIG. 5 are measured using the antenna device 100, the antenna device 200 also has similar characteristics, meaning that different sizes for the length L2 of the slot 214 of the antenna device 200 will affect the signal in a similar manner, and the length L2 can be selected to be 5 mm or more to achieve better VSWR in the 5 GHz and 6 GHz frequency bands.

FIG. 6 shows how the first angle A1 formed by bending the first radiation portion 102 of the antenna device 100 affects the beamwidth of the antenna signal. When the first angle A1 changes, it will affect the distance between the first radiation portion 102 and the bottom plate 110, thereby affecting the beamwidth of the first radiation portion 102. The radiation pattern 600 is the result measured when the first angle A1 is 90 degrees, the radiation pattern 602 is the result measured when the first angle A1 is 60 degrees, and the radiation pattern 604 is the result measured when the first angle A1 is 30 degrees. As shown in FIG. 6, the beamwidth of the radiation pattern 600 is the narrowest, while the beamwidth of the radiation pattern 604 is the widest. The appropriate first angle A1 can be selected as desired in actual situations. Although the radiation patterns in FIG. 6 are measured using the first angle A1, the second angle A2 and the third angle A3 also have characteristics similar to those shown in FIG. 6, hence the second angle A2 and the third angle A3 can be selected to be between 30 degrees and 90 degrees for adjusting the beamwidth of the signals from the second radiation portion 104 and the first radiation portion 202.

FIG. 7 shows how the distance D1 between the antenna device 100 and the top plate 118 affects the peak gain. Curve 700 represents the peak gain measured when the distance D1 is 2 mm, curve 702 represents the peak gain measured when the distance D1 is 6 mm, curve 704 represents the peak gain measured when the distance D1 is 10 mm, and curve 706 represents the peak gain measured when the distance D1 is 12 mm. When the antenna device 100 is farther away from the top plate 118, it can reduce the impact of the top plate 118 on the antenna device 100, thereby improving the peak gain. Therefore, it can be seen from FIG. 7 that in the 5 GHz and 6 GHz frequency bands, the peak gain increases as the distance D1 increases. However, in actual situations, the antenna device 100 installed in communication apparatus may be subject to spatial limitations, so there may be an upper limit to the distance D1. Choosing the distance D1 to be between 6 mm and 12 mm, for example selecting the distance D1 as 6 mm, can maintain a high peak gain while not occupying too much space, thus achieving a good balance between peak gain and spatial limitations. Although the curves in FIG. 7 are measured using the antenna device 100, the antenna device 200 also has similar characteristics, meaning that different sizes of the distance D2 between the antenna device 200 and the top plate 218 will affect the signal in a similar manner, and the distance D2 can be selected to be between 6 mm and 12 mm, for example selecting distance D2 as 6 mm, to achieve better peak gains in the 5 GHz and 6 GHz frequency bands.

The embodiments were chosen and described in order to explain the principles of the present disclosure and their practical applications. Variant embodiments will become apparent to those skilled in the art to which the present disclosure pertains without departing from its spirit and scope.

What is claimed is:

1. An antenna device, comprising:
a base;
a standing member connected to and standing on the base;
an arm comprising a first arm and a second arm, the arm being connected to the standing member; and
a first radiation portion comprising a first part and a second part that are symmetrical to each other, the first part of the first radiation portion being connected to the first arm, and the second part of the first radiation portion being connected to the second arm;
wherein the arm and the base are connected to different positions of the standing member, such that there is a distance between the arm and the base in a direction perpendicular to the base.

2. The antenna device according to claim 1, further comprising a second radiation portion, the second radiation portion comprising a first part and a second part that are symmetrical to each other, wherein the first part of the second radiation portion is connected to the first arm, and the second part of the second radiation portion is connected to the second arm.

3. The antenna device according to claim 2, wherein:
the first part of the first radiation portion and the first part of the second radiation portion are spaced apart by a first spacing in a direction connecting each other via the first arm; and
the second part of the first radiation portion and the second part of the second radiation portion are spaced apart by a second spacing in a direction connecting each other via the second arm.

4. The antenna device according to claim 3, wherein the first spacing and the second spacing are each 5 millimeters (mm) or more.

5. The antenna device according to claim 2, wherein the first part and the second part of the second radiation portion each comprise a bending part, and the bending parts are bent into an L-shape at an end of the first part and the second part of the second radiation portion, respectively.

6. The antenna device according to claim 1, further comprising a slot located in the standing member.

7. The antenna device according to claim 6, wherein in the direction perpendicular to the base, a length of the standing member is 10 millimeters (mm) or more, and a length of the slot is 5 mm or more.

8. The antenna device according to claim 6, wherein the first arm and the second arm are parallel to each other, and a gap between the first arm and the second arm is equal to a width of the slot.

9. The antenna device according to claim 1, wherein:
the first arm and the second arm are cantilevered from the standing member;
the first part of the first radiation portion is cantilevered from the first arm; and
the second part of the first radiation portion is cantilevered from the second arm.

10. The antenna device according to claim 1, wherein the first part and the second part of the first radiation portion each form a first angle with a Z-axis that is perpendicular to the base, and the first angle is between 30 degrees and 90 degrees.

11. The antenna device according to claim 2, wherein the first part and the second part of the second radiation portion each form a second angle with a Z-axis that is perpendicular to the base, and the second angle is between 30 degrees and 90 degrees.

12. The antenna device according to claim 1, further comprising a grounding terminal and a feeding terminal, wherein the grounding terminal is connected to the first arm, and the feeding terminal is connected to the second arm.

13. The antenna device according to claim 1, further comprising a first matching protrusion and a second matching protrusion for adjusting impedance matching, wherein the first matching protrusion is connected to the first arm, and the second matching protrusion is connected to the second arm.

14. The antenna device according to claim 2, wherein:
the first radiation portion operates in a first frequency band; and
the second radiation portion operates in a second frequency band that is different from the first frequency band.

15. The antenna device according to claim 14, wherein:
a total length of the first radiation portion is approximately equal to 0.5 times the wavelength corresponding to the first frequency band; and
a total length of the second radiation portion is approximately equal to 0.5 times the wavelength corresponding to the second frequency band.

16. A communication apparatus, comprising:
a bottom plate; and
an antenna device, comprising:
a base mounted on the bottom plate;
a standing member connected to and standing on the base;
an arm comprising a first arm and a second arm, the arm being connected to the standing member; and
a first radiation portion comprising a first part and a second part that are symmetrical to each other, the first part of the first radiation portion being connected to the first arm, and the second part of the first radiation portion being connected to the second arm;
wherein the arm and the base are connected to different positions of the standing member, such that there is a distance between the arm and the base in a direction perpendicular to the base.

17. The communication apparatus according to claim 16, further comprising a top plate located above the antenna device, wherein a distance between the top plate and the antenna device is 6 millimeters (mm) or more.

18. The communication apparatus according to claim 16, further comprising a second radiation portion, the second radiation portion comprising a first part and a second part that are symmetrical to each other, wherein the first part of the second radiation portion is connected to the first arm, and the second part of the second radiation portion is connected to the second arm.

19. The communication apparatus according to claim 16, further comprising a slot located in the standing member.

20. The communication apparatus according to claim 18, wherein the first radiation portion forms a first angle with a Z-axis that is perpendicular to the base, the second radiation portion forms a second angle with the Z-axis, the first angle is between 30 degrees and 90 degrees, and the second angle is between 30 degrees and 90 degrees.
